(19) United States
(12) Patent Application Publication
(10) Pub. No.: US 2019/0244252 A1
(43) Pub. Date: Aug. 8, 2019

(54) MEDIA PLATFORM SYSTEM AND METHOD OF USE

(71) Applicant: Ryan Hinkins, Sandy, UT (US)

(72) Inventor: Ryan Hinkins, Sandy, UT (US)

(21) Appl. No.: 16/057,985

(22) Filed: Aug. 8, 2018

Related U.S. Application Data
(60) Provisional application No. 62/627,090, filed on Feb. 6, 2018.

(51) Int. Cl. G06Q 30/02; G06F 17/30; G06Q 30/06

(52) U.S. Cl. CPC G06Q 30/0269; G06Q 30/0273; G06Q 30/0601; G06F 17/30876

(57) ABSTRACT

A method of advertising and creating revenue from a passenger on a flight includes providing the passenger with an electronic device owned and operated by the passenger, the electronic device to access a media platform either with or without internet or WiFi; accessing a database of relevant flight data, the relevant flight data including one or more of a destination, an origination, and a passenger data; and providing an advertisement to the passenger on the flight via the electronic device, the advertisement being tailored to the specific client based on the database of relevant flight data; the advertisement is based on matching the relevant flight data with retail provider data; and the platform provides ancillary revenue to an airline.

### BACKGROUND

### 1. Field of the Invention

The present invention relates generally to airline in-flight digital systems, and more specifically to an airline in-flight media platform and method configured to provide revenue for advertisers, as well as the airline, while in flight, both with and without internet/WiFi.

### 2. Description of Related Art

Aircraft business operators and airlines have struggled to adapt to the in-flight digital environment and face a moment of transformative disruption. The current system of in-flight retail distribution cut into profit margins and prevent airlines from forming ongoing relationships with passengers. At the same time new “digital invaders”, companies built with technology at their core, are redefining the future of the digital customer experience for many industries.

Aircraft businesses face many challenges, including the increasingly mobile and digitally connected consumer, the demand for omni-channel interactions; the need for personalized and seamless experience for the passenger; and the conventional pay to play systems.

Aircraft business are hampered by decades old technology systems, and in order to stay abreast ever growing technology, must take back control of their retail experience, and reimagine their businesses for a new era of connected commerce, where competitive advantage is awarded to those that act most rapidly on digital change.

The system and method of the present invention provides for a way for aircraft businesses to build connected commerce systems and take control of relationships with airline customers. The system and method further provides for the ability to maximize in-flight retail offerings in a connected commerce system, having point of sale systems, and utilizing unique and vast amounts of unused data.

There are three key areas that will determine the success of aircraft businesses: (1) Addressing the growing impact of mobile technology and the expectations it creates for immediate, constantly-connected passengers; two of the most important characteristics of tomorrow's connected commerce airline retailers are speed and flexibility, the truth is that the customer journey of today's traveler requires a higher degree of instant gratification and real-time responsiveness than ever before. This means that airlines' digital experiences must be immediate, connected and intelligent across an increasing volume of digital channels, devices and touchpoints. This demand for instant gratification and real-time connection is all the more imperative for airline retailers because most of their opportunity to offer additional upsell services. (2) Supporting omni-channel interactions with customers, where customer engagement happens across a range of touchpoints. A channel that's seeing more interest from airline retailers is in-flight. Although many airline retailers recognize the importance of communicating with passengers before and after flights, the in-flight experience represents a rapidly expanding frontier for many airline retailers to communicate with, and sell products to, passengers. (3) Using technology to deliver more personalized, seamless, products and services to passengers. The vast wealth of data airlines have about customer habits and their preferences offers an opportunity to provide highly personalized communications and offers to guests. Another example of the need for better personalization comes from a 2015 survey co-created by Datalex and Atmosphere Research Group, in which 67% of airline executives said they were “extremely ineffective” or “somewhat ineffective” at targeting and personalizing ancillary retail offers to passengers. Nearly 50% also said their customer data was currently “somewhat ineffective” at targeting and personalized ancillaries.

The system of the present invention provides a unique business model, with revenue sharing agreements on digital products (the system and method does not charge for the platform discussed herein). The system and method provides for the opportunity to subsidize connectivity costs and improve the bottom line through increased ancillary income and improved passenger experiences.

The system and method of the present invention provides both ancillary income, as well as an improved passenger experience while on the flight.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified schematic of the media platform system in accordance with a preferred embodiment of the present application;

FIG. 2 is a simplified diagram of a passenger portal of FIG. 1;

FIG. 3 is a simplified diagram of an administrative portal in accordance with the preferred embodiment of the present application;

FIG. 4 is a flowchart of the method of use of the system of FIG. 1 from the perspective of the passenger; and

FIG. 5 is a flowchart of the method of use of the system of FIG. 1 from the perspective of administration.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional in-flight media systems. Specifically, the present invention provides a means to create ancillary revenue for the airline business, as well as provide for an improved passenger experience. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

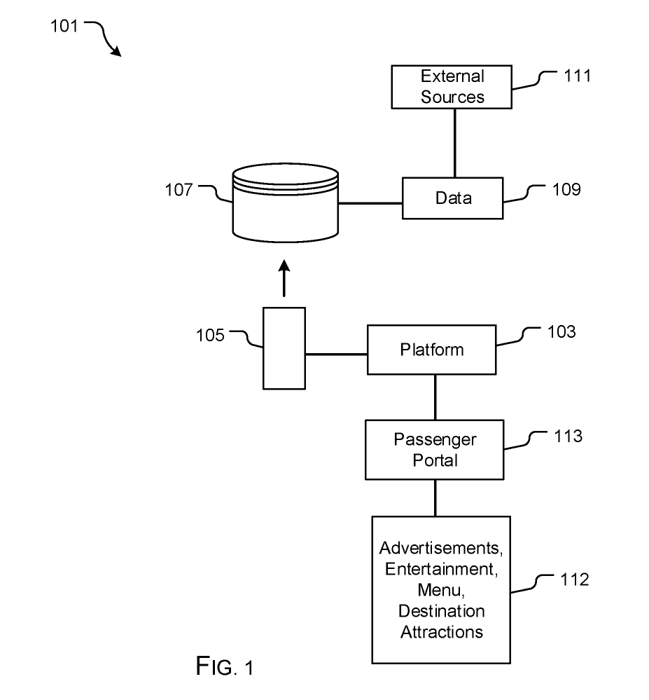

Referring now to the drawings wherein like reference characters identify corresponding or similar elements throughout the several views, FIGS. 1-5 depicts various views of a media platform system and method of use in accordance with a preferred embodiment of the present application. It will be appreciated that the system and method overcome one of more of the above-listed problems commonly associated with conventional inflight media systems.

In the contemplated embodiment, system 101 includes a media platform 103 being accessible via a computing device 105. It should be appreciated that the computing device 105 is a passenger's personal device, and is configured to access and operate platform 103 with or without internet WiFi. The system provides an in-flight advanced ancillary revenue and passenger experience mobile connected commerce technology. The airline can take control of the relationship with their passengers by adapting to digital, passenger behaviors, and capturing this retail experience of the new era in connected commerce. The system gives passengers the ability to access personalized services and content through their own electronic devices, such as smart phones, tablets, and/or computers, thereby making seat-back or other built in aircraft monitors obsolete.

Computing device 105 is configured to access a database 107 containing data 109 from one or more sources, and external sources 111 such as in flight entertainment systems. The computing device 105 does not require access to the internet, and alternatively can use a general purpose airborne media server. Platform 103 is configured to provide dynamic content to the passenger, wherein the content dynamically updates. Platform 103 is configured to provide advertisements and content 112 through the passenger portal 113. The content is based on all relevant flight data, including one or more of a destination, an origination, passenger data (seat number, profile data), etc. Further, the ecosystem can leverage rich passenger data from IFE providers so that advertisers can more effectively target potential customers. Passenger-centric analytics-enabling the gathering of granular, passenger-specific data that'll provide a clear view of passenger needs, wants, and behaviors, including travel habits, purchasing histories, personas, and travel plans.

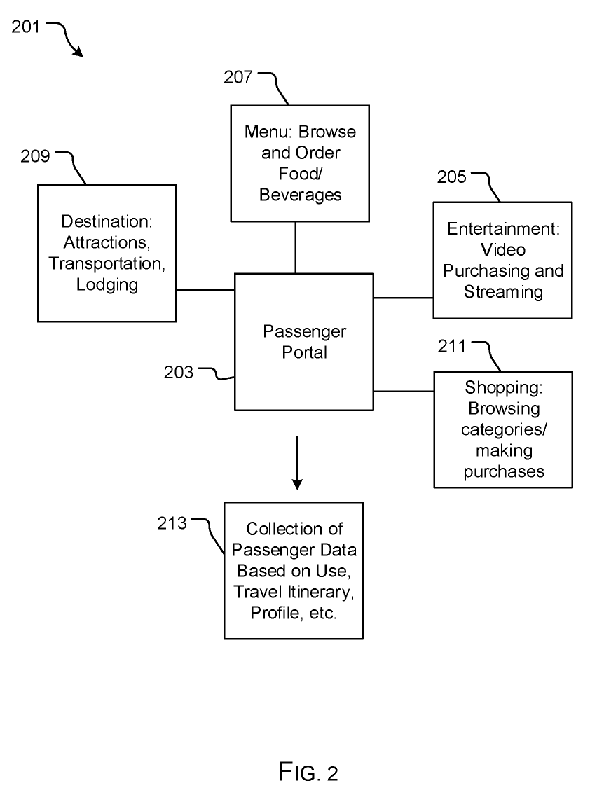

In FIG. 2, a simplified diagram 201 depicts features of the passenger portal 203. The passenger can partake in dynamically changing content through a home page, wherein the passenger can access and purchase entertainment 205 such as videos and the like. The passenger can browse, order, and pay for menu items 207. The passenger can browse destination items 209 such as transportation, lodging, and attractions. The passenger can shop 211. It should be appreciated that as the passenger uses the platform, data 215 is collected to be used to dynamically update the content.

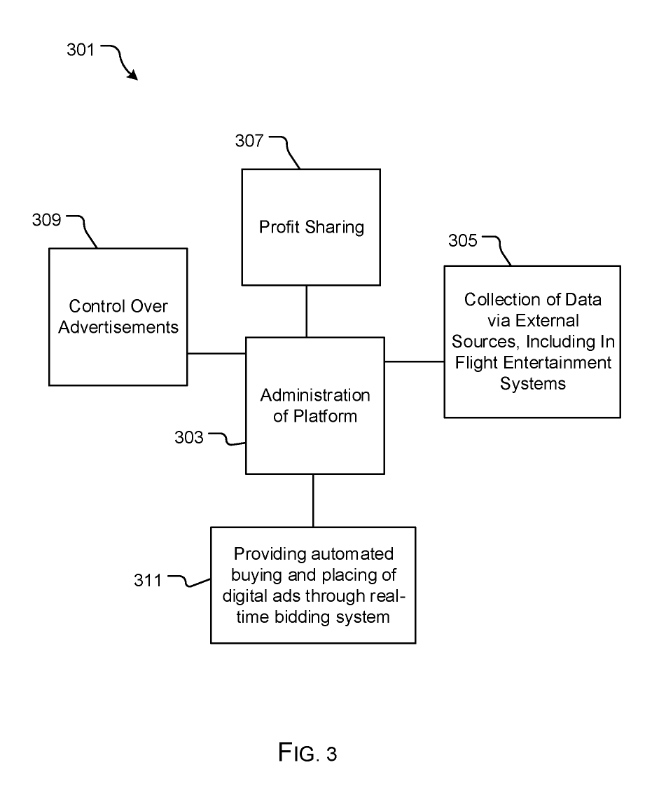

In FIG. 3, a simplified diagram 301 depicts the back end/administration 303 of the platform. Data 305 is constantly being collected from one or more sources. Payments are received from passengers, wherein profit sharing 307 provides for revenue generation by the airline as well as the advertiser. The airline maintains control over advertisements 309. Further, the administration allows for buying and placing of digital ads through real-time bidding systems 311.

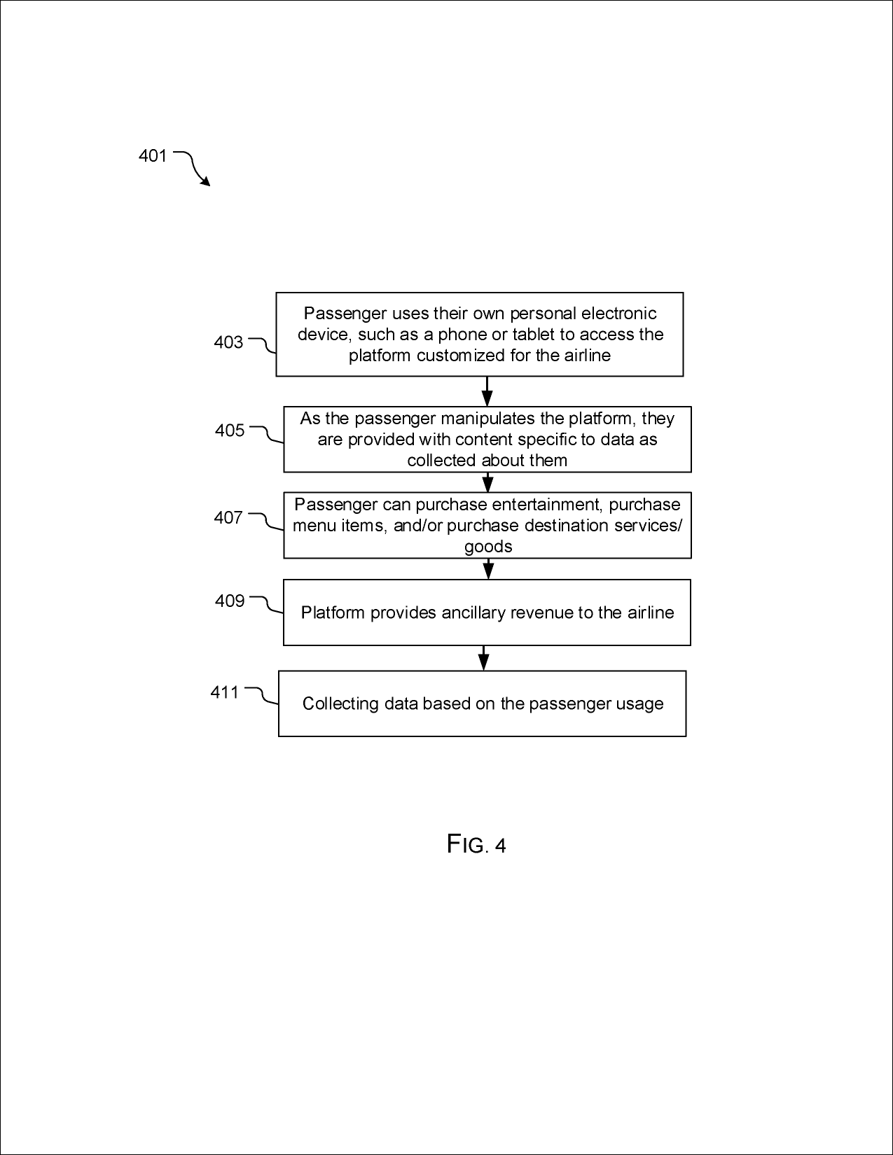

In FIG. 4, a first flowchart 401 depicts the method of use of the system and method from the perspective of the passenger. The passenger uses their own personal electronic device, such as a phone or tablet to access the platform customized for the airline, as shown with box 403. As the passenger manipulates the platform, they are provided with content specific to data as collected about them, as shown with box 405. The passenger can purchase entertainment, menu items, destination services, and goods, as shown with box 407. Data is continually collected and revenue is generated, as shown with boxes 409, 411.

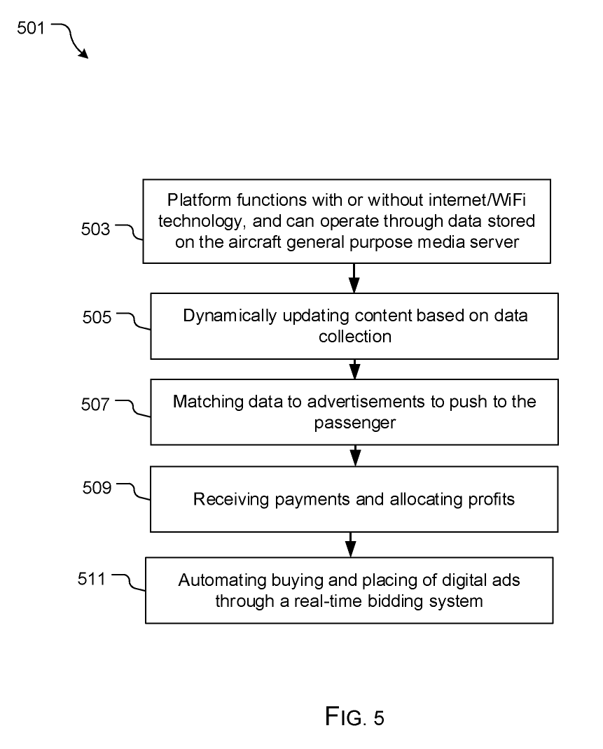

In FIG. 5, a second flowchart 501 depicts the method of use of the system and method from the administration perspective. The platform functions with or without internet/WiFi technology, and can operate through data stored on the aircraft general purpose media server, as shown with box 503. Content is dynamically updated based on data collection, as shown with box 505. The data is used to provide tailored content to each user, as shown with box 507. Payments are received and revenue is distributed, according to profit sharing agreements, as shown with box 509. Advertisers are provided with automating buying and placing of digital ads through a real-time bidding system, as shown with box 511.

Further, “Browser within a browser” web portal for website targeting of ads and customer search ads and further e-commerce and destination-based transactions. Video advertising trading platform-programmatic advertising to in-transit media markets-offering programmatic advertising in flight without the need for an off-board connection. programmatic video platform dedicated in-transit media-Avion allows the automated buying and selling of media on Bring-Your-Own-Device systems in the IFEC and onboard entertainment space, even in disconnected environments. Software-driven algorithms to automate the buying, placing and optimization of digital ads through a real-time bidding system-a marketplace that shares the available ad opportunities on our IFE portal with potential advertisers. Dedicated commerce platform-payment automatically taken from a person's account on third-party wallets.

The product is designed to be bundled online and offline [served via internal servers on planes]. This is achieved by using a lightweight node framework and client segmentation. The platform has a full underlying back end, where each individual client can match menus, inventory, video libraries, listings and advertisements to a plane via tail #, destination or user IP range. This administration console allows for complete customization for each individual client and flight. Widgets as listed above can be placed into one of 3 layouts on demand, lower menu, stacked card or dynamic layover scroll, where a video or add can play behind rows of items. All views are responsive and dynamic. The main menu which can be differentiated for each client/plane is built upon a home screen editor where clients can drag and drop what they desire and even determine the size of individual widget cards on the main menu. This process is dynamic and can be changed on demand. The product is designed to be updated in real time or when the plane is on the ground.

It should be appreciated that one of the unique features believed characteristic of the present application is the platform has the capability to provide aircraft operators, airlines, passengers and content providers w/the full potential of a digitally connected aircraft and increase ROI and ancillary revenues-without the excessive costs associated from other suppliers.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A method of advertising and creating revenue from a passenger on a flight, the method comprising:
providing the passenger with an electronic device owned and operated by the passenger, the electronic device configured to access a media platform either with or without internet or WiFi;
accessing a database of relevant flight data, the relevant flight data including one or more of a destination, an origination, and a passenger data; and
providing an advertisement to the passenger on the flight via the electronic device, the advertisement being tailored to the specific client based on the database of relevant flight data;
wherein the advertisement is based on matching the relevant flight data with retail provider data; and
wherein the platform provides ancillary revenue to an airline.

2. The method of claim 1, further comprising:
accepting payment via the platform from the passenger based on the passenger purchasing a good or service based on the advertisement.

3. The method of claim 1, further comprising:
directing a profit sharing allocation between an airline and a retailer based on the passenger purchasing a good or service from the advertisement.

4. The method of claim 1, further comprising:
operating the platform on an aircraft without WiFi through data stored on an aircraft general purpose media server.

5. The method of claim 1, further comprising:
collecting passenger data via one or more in-flight entertainment systems.

6. The method of claim 5, wherein the passenger data includes one or more of passenger purchasing history; passenger personas; passenger travel plans; past passenger travel itineraries.

7. The method of claim 1, further comprising:
providing video advertising trading platform; and
offering programmatic advertising in flight without the need for an off board connection.

8. The method of claim 1, further comprising:
automating buying and placing of digital ads through a real-time bidding system, the real time bidding system being a marketplace that shares available ad opportunities with potential advertisers through a portal.

9. The method of claim 1, further comprising:
providing entertainment to the passenger via the platform.

10. The method of claim 1, further comprising:
providing a plurality of shopping categories to the passenger via the platform.

11. The method of claim 1, further comprising:
providing a plurality of destination services to the passenger via the platform, wherein the passenger can purchase one or more of the destination services, the destination services including one or more of transportation, lodging, and entertainment.

12. The method of claim 1, further comprising:
providing a menu to the passenger via the platform, the platform allowing for the passenger to purchase one or more food or beverage items from the airline.

13. The method of claim 1, wherein the media platform includes a home page configured to dynamically change based on the passenger.
